(19) United States
(12) Patent Application Publication
(10) Pub. No.: US 2012/0062147 A1
(43) Pub. Date: Mar. 15, 2012

(54) High efficiency drive method for driving LED devices

(75) Inventor: Jianping Fan, Orange, CA (US)

(73) Assignee: SUNTEC ENTERPRISES

(21) Appl. No.: 12/923,284

(22) Filed: Sep. 13, 2010

(51) Int. Cl. H05B 41/36

(52) U.S. Cl. 315/297

(57) ABSTRACT

A set of unique concept of driving multiple LED strings with non-dissipative current balancing and non-dissipative synchronous current regulation is disclosed. Inductive components and capacitive components are utilized in the non-dissipative current balancing approach to drive the LED strings from AC supply source. The synchronous regulation method regulates the LED current with pulse width modulated switching action in synchronous with the AC supply source frequency. Both simultaneous and independent control of the LED string operation can be realized with synchronous regulation method when combined with suitable circuit configuration.

### BACKGROUND OF THE INVENTION

1. Field of the Invention

This invention generally relates to methods and apparatus of driving LED devices, and more particularly, to some unique techniques to drive multiple LED devices with low cost circuits while minimizing the power dissipation in LED current regulation and dimming control.

2. Description of the Related Art

Light Emitting Diode (referred as LED hereinafter) is bringing revolutionary changes to the lighting industry and the world economy. High efficiency, compact size, long life and minimal pollution etc. are some of the main advantages that provide people elegant lighting solutions and in the meanwhile perfectly fit into the green power initiative. Because LED is made with solid substances, in lighting industry it is also called Solid State Lighting (referred as SSL hereinafter) device. The inherent mechanical robustness of SSL device together with the features described above also enable itself to provide more reliable solutions that other lighting devices cannot do, and create many new applications in our daily life. Among them general lighting and display backlighting are the fastest growing areas with enormous economic potentials.

Despite the various advantages of the LED device, the relatively high cost of the device and the drive circuitry and low power handling capability also draw major concerns in its applications and design considerations. Because of the high cost of high power LED, e.g. devices around 1 W or so, and thermal management challenges related to the concentrated heat dissipation, most applications today use a high number of low power LED's normally from a few tens to a few hundreds to provide the particular light intensity required for the application. With such high number of devices, circuit configuration is inevitably one of the top level design considerations that largely defines the architecture and total cost of the lighting system.

As is well known that the current-voltage characteristics of LED device is similar to a normal diode except the higher forward conduction voltage in a typical range of 2.2V to 3.3V. When the LED is forward biased, its forward current increases considerably with a small increase of the forward voltage, resulting in a steep current-voltage curve in the conduction region. This nature obviously gives rise to a challenge of LED current control when connecting multiple devices in parallel. In practice a group of LED's are normally connected in series to form an LED string in order to reduce the number of parallel branches and the complexity of the drive circuitry. But in large systems such as LCD backlight applications multiple LED strings still have to be used because of the limit of string voltage from safety and other design concerns and system reliability considerations. In such cases the brightness matching or current balancing of the LED strings becomes a major challenge in the system design. Mismatched LED current will result in uneven brightness distribution and deterioration of the system life. Further, in LCD backlight applications each LED string may need to be turned on and off at a particular time with different brightness in correspondence to the video signal display in order to obtain optimum picture quality and minimum power consumption. Such requirement brings another challenge to the LED drive control.

FIG. 1 shows a typical conventional approach of driving multiple LED strings. For simplicity of the description, the figure shows only the symbolic circuit configuration. As shown in FIG. 1, the LED array 210 consists of multiple LED strings LED1 through LEDK. These LED strings are essentially connected in parallel to a common drive supply 100 on their anode side, and with a regulation device 132, represented as a MOSFET herein, and current sense resistor 142 connected in series with each string from the cathode side to power return ground GND. The current of the LED string is sensed from the sense resistor 142 and fed back to the inverting input of the corresponding error amplifier 82 and compared with the LED current reference signal IREF. The output of the error amplifier 82 then controls the gate of regulation device 132 to maintain the LED current at the value set by the reference signal IREF. In addition, a control switch 72, also represented as a MOSFET herein, is connected from the output of each error amplifier to ground. The gate of switch 72 is controlled by a periodic pulse train signal DPWM. When the DPWM signal is at high state the control switch 72 is turned on and thus switching off the regulation device 132 to cut off the LED current, and when DPWM is at low state the regulation device 132 resumes normal operation to regulate the LED current at the set value. Therefore by changing the time of low state of the DPWM signal the working duty of the LED current can be controlled accordingly to adjust the average brightness of the system. This type of brightness control is called digital dimming in the lighting industry in contrast to the term of analog dimming, which controls the amplitude of the LED current to adjust the brightness. Because the light conversion efficiency of the LED device varies with its forward current, digital dimming becomes the most popular approach in brightness control where the LED current can be set at a sweet spot value to yield the optimum operating efficiency.

In the above described system the LED current is essentially regulated by adjusting the voltage drop on the regulating device 132 to compensate the difference of the forward conduction voltage of the LED strings. The regulating device 132 works in a linear mode to dissipate the power resulted from the LED current and the difference between the drive supply voltage VDC+ and LED string voltage. In order to minimize such power dissipation the drive supply voltage VDC+ is always controlled at a minimum level that is just sufficient to maintain the current of the LED string with the highest forward voltage at the set value. This is accomplished by feeding the drain voltage of each regulation device 132 to the control circuit of drive supply 100. The lowest drain voltage signal will dominate the control to maintain the drive supply voltage VDC+.

Even though with the above minimum voltage control, the regulating device still has to dissipate the power resulted from the difference of the forward conduction voltage (it will be referred to as operating voltage hereinafter) of the LED strings. In practice the variation of LED operating voltage is quite large. Even with sorting in the manufacturing process the variation of the LED string operation voltage in each group still lies in the range of about 5% to 10% of its nominal operating voltage, which means that the maximum power dissipation on the regulating MOSFET could be about 10% of the power consumption of the LED string. Such dissipation not only reduces the efficiency of the system, but also generates excessive heat that creates thermal problems, resulting in higher design complexity, higher system cost and lower reliability. If a short fault occurred with an LED element in a string, the corresponding regulating device has to drop additional voltage of the shorted LED and dissipate more power, which in turn will often result in over temperature of the device. Further from FIG. 1, in the conventional system the drive supply power for the LED strings is first converted from the 400V output of the Power Factor Correction (referred as PFC hereinafter) stage 10 to a standard low DC voltage, normally 24V as indicated in the figure, and then processed by another power conversion stage 100 to get the desired drive voltage to supply the LED strings. Such approach involves multiple power conversion stages that on one hand lowers the system efficiency and on the other hand holds the system cost high, both resulting in critical disadvantages to the further success of the LED lighting solutions. Therefore it is the intention of this invention to introduce a set of innovative LED drive method, particularly for multiple LED string applications, to yield higher operating efficiency and lower system cost to offer more competitive solutions to the market.

### SUMMARY OF THE INVENTION

This invention discloses a set of concept to drive multiple LED devices with unique current balancing technique, high efficiency circuit operation and simplified power conversion process. The proposed concept eliminates the conventional dissipative current balancing approach and instead, uses a set of non-dissipative balancing concept to drive multiple LED strings with matched brightness and current control. Considerations are also taken to drive the LED devices with minimized power conversion process, reliable device fault handling, and elimination of high voltage sensing circuitry etc. to provide practical high efficiency, low cost drive solutions for LED lighting and backlight applications. Finally, a unique concept is disclosed to control the current and digital dimming duty of the LED strings independently with a non-dissipative drive method.

In one embodiment a balancing network with center-tapped balancing transformer is introduced to provide a loss-less current balancing for the LED strings. Particular considerations are made to maintain AC excitation for the transformer core while supplying DC current to the LED strings through the transformer windings. Apart from the loss-less balancing function, the balancing network also provides easy fault detection and robust fault tolerant operations.

In one embodiment center-tapped balancing inductor is introduced to provide a loss-less current balancing for the LED strings by matched inductive impedance. Particular considerations are made to maintain AC excitation for the inductor core while supplying DC current to the LED strings through it. Because there is no electro-magnetic coupling between the balancing inductors, each LED string can be turned on and off independently.

In one embodiment the balancer-LED string network is connected to an AC or pulsed DC supply and a regulation device is connected in series with the common return of the balancer-LED string network. The LED string current is regulated by the regulation device in switching manner by adjusting the PWM duty or the number of switching cycles. The switching action of the regulation device is preferably in synchronous with the frequency of the supply power.

In another embodiment the LED strings are controlled independently with separate regulation devices. The leakage inductance of the transformer winding is utilized to balance the LED current. The regulation switch further improves the current balancing accuracy by PWM switching regulation and in the meanwhile, controls the digital dimming operation by turning on and off its switching action in accordance with the digital dimming signal.

### BRIEF DESCRIPTION OF THE DRAWINGS

FIG. 1 shows a conventional LED drive system approach that consists of a PFC stage, a DC to DC voltage conversion stage, and LED drive control stage with dissipative linear LED current regulation.

FIG. 2 shows a typical LED current balancing method with a center tapped balancing transformer to obtain AC excitation for the transformer core while supplying DC current to the LED strings.

FIG. 3 shows another circuit configuration of the center-tapped transformer balancing scheme with separate rectification devices for each LED branch.

FIG. 4 illustrates a concept of using center-tapped inductor to balance the current of multiple LED strings.

FIG. 5 shows the concept of using a synchronous regulation switch to regulate the balancing transformer coupled multi-string LED current with additional digital dimming control function.

FIG. 6 shows a concept of using a synchronous regulation switch to regulate a balancing inductor coupled multi-string LED current with digital dimming control function.

FIG. 7 shows an example of using the leakage inductance of the power transformer winding to balance the multi-string LED current and use a synchronous regulation switch to regulate the LED current with digital dimming control function.

FIG. 8 shows the concept of using center-tapped inductor in combination with synchronous regulation switch to realize current regulation and digital dimming control with independent operation for each of the multiple LED strings.

FIG. 9 shows the concept of using leakage inductance of multiple winding transformer in combination with synchronous regulation switch to realize current regulation and digital dimming control with independent operation for each of the multiple LED strings.

FIG. 10 shows the concept of using leakage inductance of single drive winding transformer in combination with synchronous regulation switch to realize current regulation and digital dimming control with independent operation for each of the multiple LED strings.

FIG. 11 shows a concept using non-center tapped inductive balancing components to drive multiple bi-directional LED string structures.

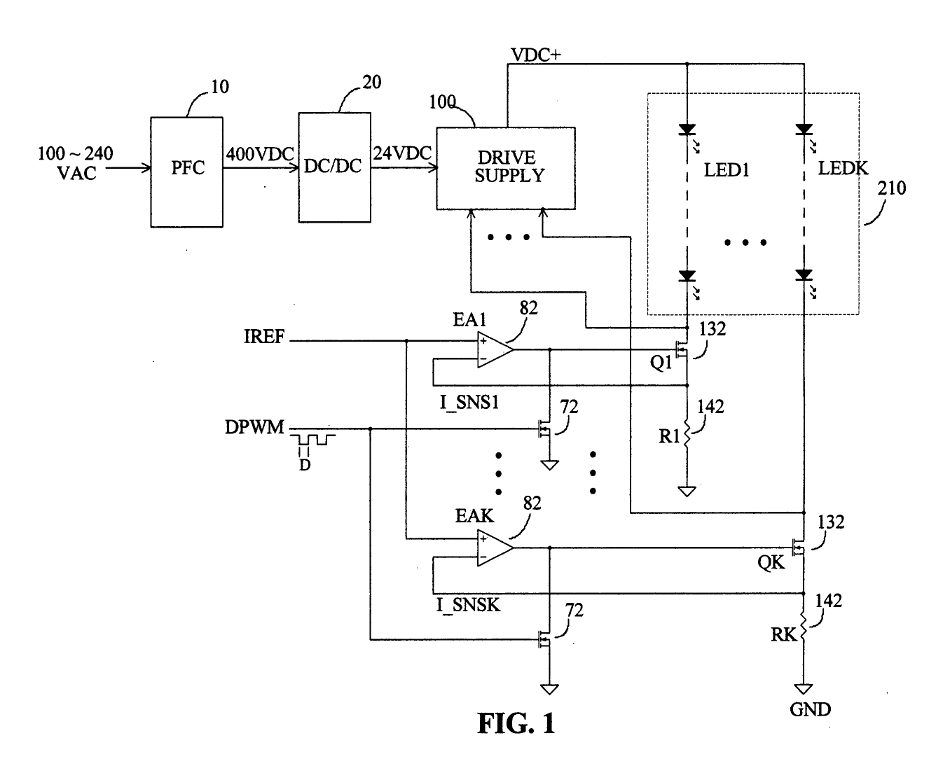

### DETAILED DESCRIPTION OF THE INVENTION

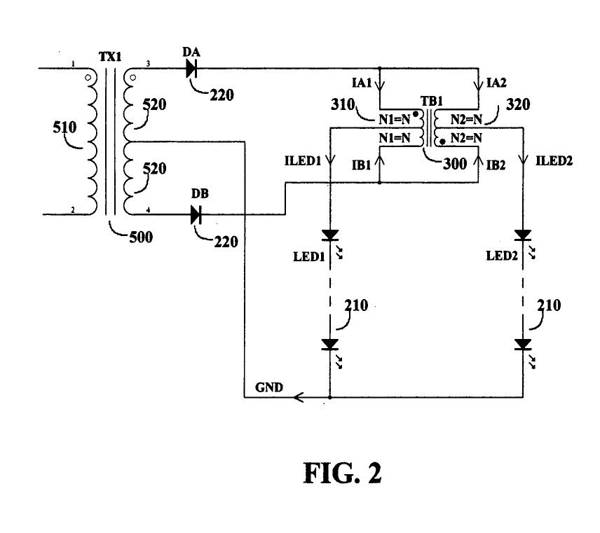

As described above that the purpose of this invention is to provide an optimum approach to drive multiple LED strings with high efficiency operation and low system cost. Therefore the concept disclosed herein does not use any type of dissipative drive method for the LED control. The first concept is to use center-tapped magnetic components to drive multiple LED strings. FIG. 2 shows an example of such approach. As shown in FIG. 2, a power transformer 500 supplies drive power from its center-tapped secondary winding 520 to the LED strings 210, through the rectifier diode 220 and balancing transformer 300. Balancing transformer 300 has two windings 310 and 320 with equal number of turns and both have a center tap. The two rectifier diodes D1 and D2, represented as 220 are connected between the two supply terminals of the power transformer secondary winding and the receiving terminals of the balancing transformer. The two LED strings LED1 and LED2, represented as 210, are connected between the respective center tap of the balancing transformer winding 310 and 320 and the center tap of the power transformer winding 520. The connection of the rectifier diodes and the LED strings is in the polarity relation such that both devices are forward biased in the same current flowing direction in the loop formed between the half secondary winding of the power transformer and the half winding of the balancing transformer.

The polarity relation of the two windings of balancing transformer is such that when current flows from rectifier diode DA or DB to the windings, the fluxes generated by the current in the two windings cancel each other. With such winding polarity relation the following current balancing equation holds at normal operation conditions:

N1·IA1=N2·IA2

N1·IA1=N2·IA2 [EQU. 1]

Referring to FIG. 2 here N1 and N2 represent the number of turns of each half of the balancing transformer winding 310 and 320. So when both windings use the same number of N turns, the currents flowing through the two windings are equal, i.e.

N1=N2=N

IA1=IA2,IB1=IB2 [EQU. 2]

Note that the above equations hold only when there is no continuous DC biased magnetization of the transformer core. Such condition is realized by the center-tapped winding structure of the balancing transformer and the power transformer. As can be obviously understood by the skilled in the art, when a symmetric AC voltage is supplied to the primary winding 510 and converted to another voltage from the secondary winding of the power transformer 500, in one half cycle where the voltage at the upper terminal of 510 is positive (hereinafter refers as positive half cycle), current flows in the loop through the rectifier diode DA, upper half of the balancing transformer windings 310 and 320, the LED strings LED1 and LED2, and returns to the center tap of the power transformer secondary winding. And vice versa in another half cycle where the voltage at the lower terminal of 510 is positive (hereinafter refers as negative half cycle), current flows in the loop through the rectifier diode DB, lower half of the balancing transformer windings 310 and 320, the LED strings LED1 and LED2, and returns to the center tap of the power transformer secondary winding. With such circuit operation the balancing transformer core is magnetized alternatively in opposite polarities during the positive and negative half cycle of the supply voltage, without any biased DC magnetization exist. The end result is that when balanced DC current is supplied to the LED strings through the upper and lower half of the balancing transformer windings, the balancing transformer core is magnetized with AC flux, which in turn maintains an ideal condition for the balancing transformer operation.

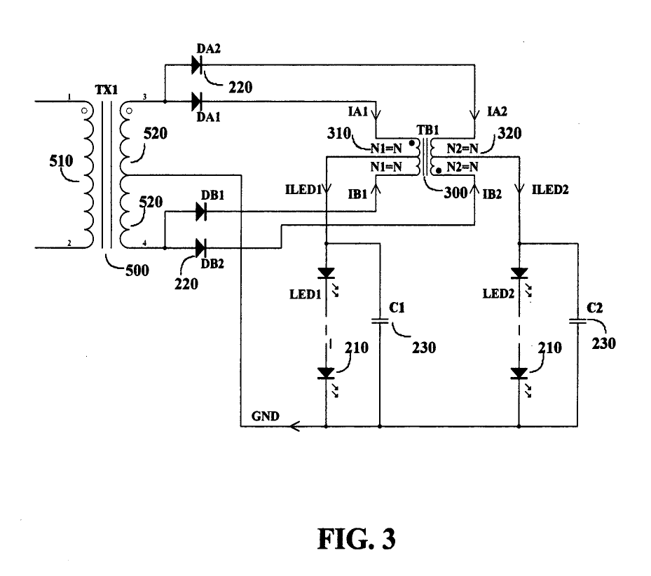

The circuit configuration in FIG. 2 can work with both continuous and discontinuous AC voltage supplied to the power transformer. Smooth capacitor can also be connected in parallel with the LED strings as illustrated in FIG. 3 to obtain continuous DC current for the LED strings. However, when a discontinuous AC voltage waveform is supplied to the power transformer, care has to be taken to prevent cross coupling of the energy between the smoothing capacitors during the zero crossing period of the AC voltage. Such situation happens when the rectifier diodes DA and DB are shared by the two windings of the balancing transformer, because during the zero crossing period of the AC voltage both rectifier diodes DA and DB are at open state and cross energy flow could happen between smoothing capacitor C1 and C2 which would further affect the accuracy of the LED current balancing. To prevent such situation the circuit can be modified to use separate rectifier diode for each LED branch, as illustrated in FIG. 3. As shown in FIG. 3, the rectifier diode DA in FIG. 2 is replaced by two diodes DA1 and DA2 to connect to the upper terminals of the balancing transformer winding 310 and 320 respectively, and the rectifier diode DB in FIG. 2 is replaced by two diodes DB1 and DB2 to connect to the lower terminals of the balancing transformer winding 310 and 320 respectively. Such configuration allows the circuit to work with discontinuous AC waveforms with the presence of the smoothing capacitor 230 as shown in FIG. 3. With such circuit arrangement the energy flow path between the smoothing capacitors is cut off, and the balancing accuracy of the capacitor smoothed LED current can be guaranteed with both continuous and discontinuous AC supply voltages. It should be noted that circuit examples in FIG. 2 and FIG. 3 can cascaded to drive more than two LED strings. Such cascaded circuit configuration can be easily understood by the skilled in the art and will not be elaborated further here. Also note that the polarity of the rectifier diodes and the LED strings in the circuit can be reversed to satisfy the rule described in the last sentence of paragraph [0024] to keep them forward biased simultaneously in the current flowing loop.

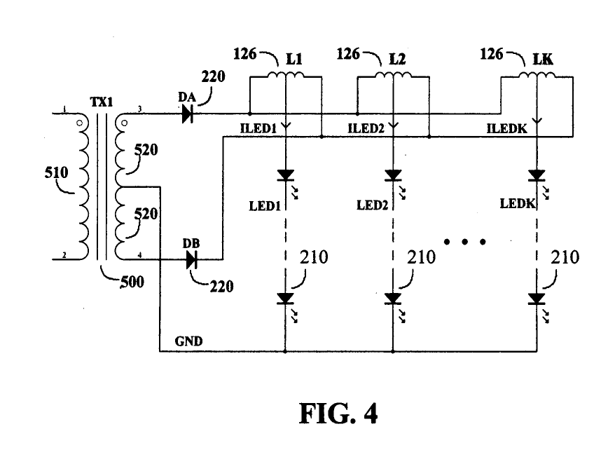

Except using balancing transformer, center-tapped inductor can also be used to facilitate current balance for multiple LED strings. FIG. 4 shows such an example. As shown in FIG. 4, a plurality of LED strings LED1 through LEDK are connected between the center tap of each respective balancing inductor L1 through LK, represented as 126 in FIG. 4, and the center tap of the power transformer secondary winding 520. A rectifier diode DA is connected between the upper terminal of 520 and the left side terminals of the center-tapped inductors 126, and rectifier diode DB between the lower terminal of 520 and the right side terminals of 126. When an AC voltage is supplied to the power transformer 500, during positive half cycle of the AC supply voltage, current flows in the loop through the rectifier diode DA, left half of the balancing inductor 126, the LED strings LED1 through LEDK, and returns to the center tap of the power transformer secondary winding, and vice versa in the negative half cycle, current flows in the loop through the rectifier diode DB, right half of the balancing inductor 126, the LED strings LED1 through LEDK, and returns to the center tap of the power transformer secondary winding. Similar to the center-tapped balancing transformer, in such circuit operation the balancing inductors are under AC magnetic excitation while DC currents are supplied from their center taps to the LED strings, where DC magnetic bias or saturation of the core is avoided. Further, when the inductive impedance of the balancing inductor is high enough with which the voltage drop across the inductor at the given operating frequency is significantly higher than the operating voltage difference of the LED strings, preferably 10 times or more, the currents of the LED strings are approximately proportional to the inductive conductance of the balancing inductors. Therefore when all the balancing inductors have the same inductance value, the current of each of the LED strings are also set to be approximately equal. Compare with the balancing transformer approach, although the balancing accuracy of such inductive balancing is lower, an advantage is that there is no electro-magnetic coupling between the inductor-LED branches, and with which each LED string can be turned on and off independently. Such advantage is desirable in lighting controls when individual LED strings need to be turned on and off at different time or with different operating duty. It should be noted that in the above balancing methods, the supply power can be an AC voltage source, or an AC current source without affect the operating result and spirit of the concept.

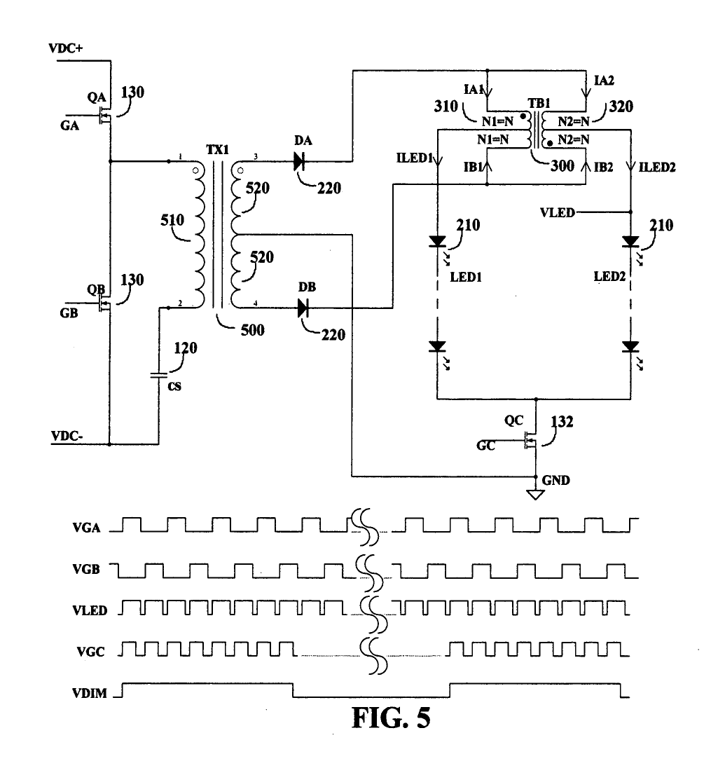

The LED drive methods described above and illustrated in FIGS. 2, 3 and 4 provide only current balancing function for multiple LED strings. The value of the LED string current is determined by the amplitude of the AC power supply and the LED operating voltage, inductive impedance of the inductor etc. Regulation of the LED current has to be performed with the AC supply power. In the case that the AC supply is not regulated to match the LED string current, a simple regulation control circuit is developed herein in combination with the balancing network to realize versatile LED current control functions. The first example is illustrated in FIG. 5. As shown in FIG. 5, the balancing circuit is essentially the same as that described in FIG. 2, but with the addition of a regulation device 132 inserted between the common return terminal of the LED strings and the center tap of the secondary winding 520 of the power transformer 500. The AC supply to the power transformer 500 is representatively provided by a half bridge switching network comprised by a pair MOSFET QA and QB, represented as 130, and a coupling capacitor 120. When the switching operation of QA and QB provides an AC supply not regulated for the LED current control to transformer 500, the regulation of the LED current is accomplished by the switching control of the regulation device 132. It should be noted that in practice, the current flowing through the loop of rectifier diode 220, the balancing transformer 300, the LED string 210 and eventually the regulation device 132 is periodic rippled DC current at the frequency twice of the switching frequency of QA and QB, therefore the switching operation of 132 should be in synchronous with the ripple frequency in order to obtain effective regulation control and avoid the sub-frequency modulation effect of non-synchronous switching operation. Regulation of the LED string current can then be accomplished by varying the switching pulse width of 132 when switching is performed in every ripple cycle, or the density of the switching pulse at fixed switching pulse width preferably at maximum pulse duty. Note that the single regulation device controls the total current of the LED strings by its switching regulation action and the regulated total current is evenly distributed to the LED strings by the balancing network.

The operating waveforms of the above approach are also conceptually illustrated in FIG. 5. In FIG. 5 the waveforms VGA, VGB and VGC represent the drive signals applied between the gate and source of QA, QB and QC respectively, VLED represents the voltage from the anode of the LED string referenced to the ground return GND to the center tap of 520, and the waveform VDIM represents a PWM signal to control the digital dimming operation of the LED strings. In practice the frequency of VGA, VGB and VGC is in the range of a few hundred KHz, and the frequency of VDIM in the range from 100 to a few hundred Hertz. During operation the switching action of the regulation device QC fulfils two functions simultaneously. The first function is regulating the LED current by varying the pulse duty of the switching action. In practice the amplitude of the voltage applied to the LED strings should be slightly higher than the highest operating voltage of them. Under such circumstance when QC is turned on in synchronous with QA or QB, the instantaneous current of the LED string is higher than the operating value which is normally set with a DC reference signal level and the pulse width of the on time of QC can be adjusted to be narrower than the on pulse width of QA and QB to make the average current of the LED string equal to the DC reference level. Because the brightness of the LED device is proportional to its forward current over a wide range, the average brightness obtained under such regulation operation equals to the desired brightness level set by the reference signal. Such regulation function is conceptually illustrated in FIG. 5 wherein the narrower pulse width of VQC represents such regulation mechanism. The second function of QC is to turn the LED current on and off following the waveform of VDIM to perform digital dimming control. Because the digital dimming frequency is much lower than the switching frequency of QA, QB and QC, the LED current can be turned on and brought to the set operating value by pulse width modulation action of QC without response time problem when VDIM is at on (logic high herein) state, and the LED current can be cut off by turning QC off when VDIM is at off (logic low herein) state to fulfill the digital dimming control function. Further, a smoothing capacitor can also be connected in parallel with each LED string to filter out the ripple of the LED current. Because capacitor cannot couple steady state DC current, the addition of the smoothing capacitor will not affect the accuracy of the LED current regulation.

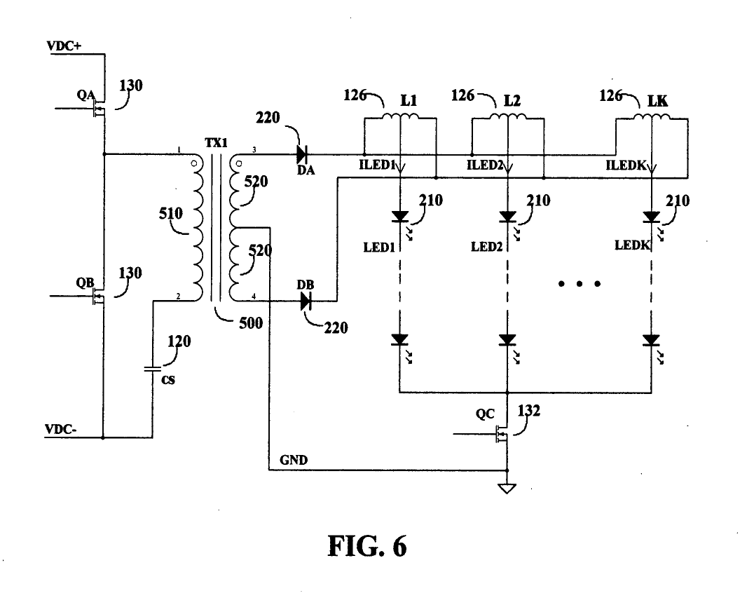

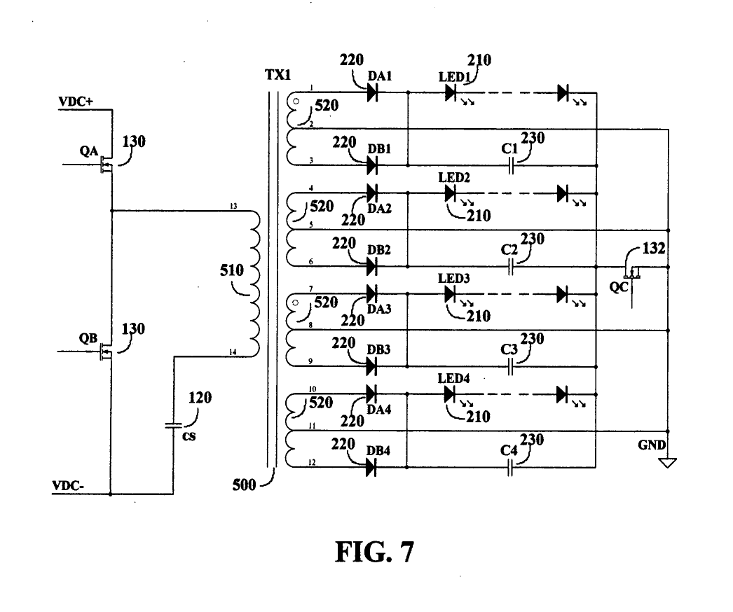

The above described synchronous regulation concept can also be applied to other types of circuit configuration. FIG. 6 shows the implementation of synchronous regulation in combination with a center-tapped inductor balancing network. In actual applications, many power converter designs purposely make the power transformer with large leakage inductance and utilize the leakage inductance to facilitate soft switching operation of the power devices. In such case the leakage inductance of the transformer winding can also be utilized to replace the external inductor 126 to balance the LED current. FIG. 7 shows the implementation of such concept. As shown if FIG. 7, the power transformer has four center-tapped secondary windings and each winding supplies a LED string through a full wave rectifier pair. The leakage inductance of the four secondary windings is purposely made equal with sufficient value to work as balancing inductance to match the LED current. The regulation switch 132 is connected between the common node of the LED strings and the center tap of the transformer secondary windings to control the LED operation. There is no doubt to the skilled in the art that in such circuit the regulation switch can fulfill both functions of LED current regulation and digital dimming simultaneously with the same operation principle, while the current control be the switch is evenly distributed among the LED strings by the matched leakage inductance. Note that although FIG. 7 shows a four secondary winding transformer, other number of secondary windings is also applicable without departing from the spirit of the concept.

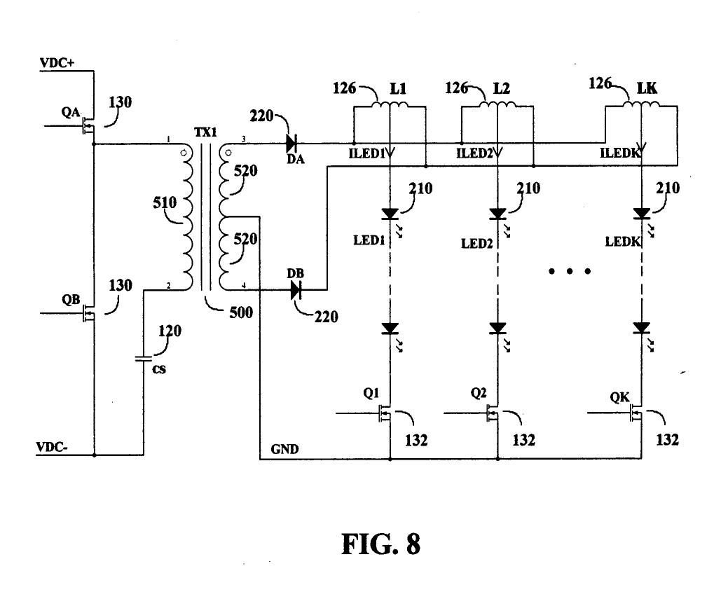

When LED is used as backlight in LCD display applications, sometimes the LED strings need to be turned on and off at different time and with different dimming duty or current level in correspondence to the content of the video signal display in order to obtain optimum picture quality and minimize the power consumption. Under such circumstances, the combination of inductive balancing and synchronous regulation provides a perfect solution for independent control of the LED strings. FIG. 8 shows such an example. As shown in FIG. 8, each LED string is connected to the center tap of a balancing inductor 126 with its anode, and a plurality of synchronous regulation devices 132 are used with each connected in series with a LED string from their cathode to ground return. As mentioned in paragraph [0027], because there is no electro-magnetic coupling between the inductors, the switching operation of the regulation device 132 of each string can be controlled independently. With the synchronous regulation and digital dimming functionality of the regulation devices, the current amplitude and the on/off time of the digital dimming operation of the LED strings can be controlled separately according to the particular control signals for each string. The gate control waveforms of the regulation device 132 is the same as that illustrated in FIG. 5, with the exception that the digital control signal for each LED string can assume different on/off time and pulse width. Also it should be particularly noted that with the regulation capability of 132, the inductance of the balancing inductor 126 can be reduced. The consequent increase of error in the instantaneous amplitude of the LED current can be corrected by the pulse width modulation control of the regulation device 132.

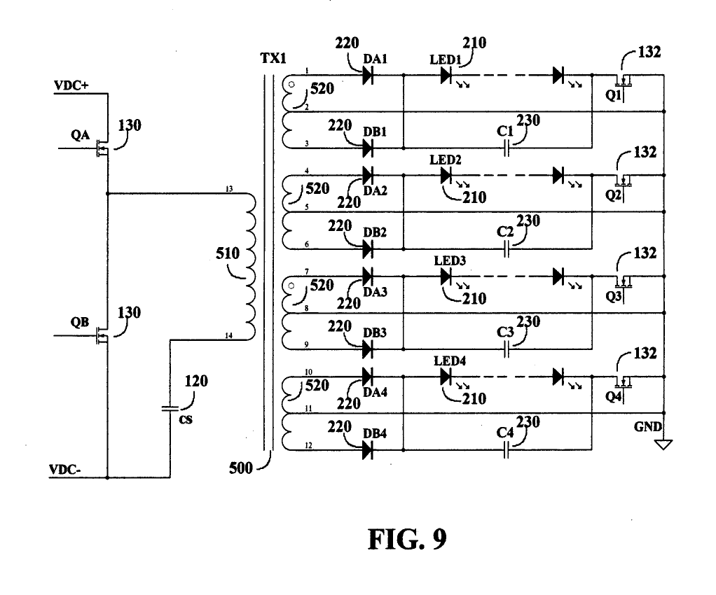

When the inductance required for the drive operation is reduced, the inductance can be obtained with lower cost method. One of the possibilities use the traces of printed circuit board (PCB) to form the inductor winding to make PCB embedded inductor. Another possibility is to use the leakage inductance of the power transformer winding. This method is particularly practical with soft switching power converters with which the leakage inductance of the power transformer is purposely made large to increase the inductive energy storage in order to obtain successful resonance for the soft switching operation. FIG. 9 shows an example of using a power transformer with four center-tapped windings to drive four LED strings. As shown in FIG. 9, a full wave rectifier circuit comprised with two diodes 220 is employed with each LED circuit. The DC voltage from the cathode of the rectifier supplies to the anode of the LED string 210 and the cathode of the LED string is connected to the center tap of the corresponding secondary winding 520 of the power transformer. Optionally a smooth capacitor 230 is connected in parallel with the LED string respectively to filter out the ripple of the LED current.

As elaborated above that the leakage inductance of power transformer 500 is utilized in this approach to work as balancing impedance for the LED current control. Care can be taken to make the leakage inductance of the four secondary windings 520 approximately equal to each other, and with such arrangement the operating current of the four LED strings will also be approximately equal when a common AC excitation is applied to the primary winding 510 even without the regulation function of 132 (e.g. to keep 132 constantly on during operation), if the inductive impedance of the leakage inductance of 520 is significant enough, as analyzed in paragraph [0027]. Under such circumstances the regulation device 132 can be removed if the LED current can meet the accuracy requirement with the regulation provided from the primary side switching control. Such approach in fact offers a very cost competitive solution, however, the utilization of the regulation device 132 will provide much more versatile functionality for the LED control. First, the current of the LED strings can be controlled accurately with synchronous regulation function of 132, and therefore the AC supply to the primary side of the power transformer 500 does not need to be regulated. Such capability allows the operation of the switching devices 130 on the primary side to be utilized for other control purposes, e.g. to control the regulation of an additional output from another secondary winding attached to the power transformer 500, or to control the regulation of another transformer connected in parallel on the primary side with the 500. Such arrangement will essentially save the cost of a complete set of power conversion stage or at least a switching network on the primary side. Second, with the regulation function of 132, the accuracy of the LED current can be always maintained even if the leakage inductance of 520 is not high enough to meet the required LED current matching. This will allow wider parameter range or lower cost design for the power transformer. Third, because the output of the four secondary winding is essentially independent with minimal cross coupling effect, the current amplitude of the LED strings attached to each particular winding and the on/off time of them can be controlled independently. This property allows such system to be used in more sophisticated backlight control applications where the brightness and on/off timing of each LED string need to be controlled separately according to the video display content. It is re-emphasized herein that the synchronous regulation capability of 132 can be utilized to realize both the LED current regulation and digital dimming control and therefore provides versatile functionality for almost all the backlight control applications at competitive system cost. It should also be noted that although four secondary windings are illustrated in FIG. 9, in actual applications different number of secondary windings can be adopted according to the number of LED strings to be driven without theoretical limitation. The gate control waveform of 132 has the same format as shown in FIG. 5 except that each LED string in FIG. 9 and may have different current reference and digital dimming control signal, and the gate control signal has to adjust accordingly to meet the control requirement for the specific LED string.

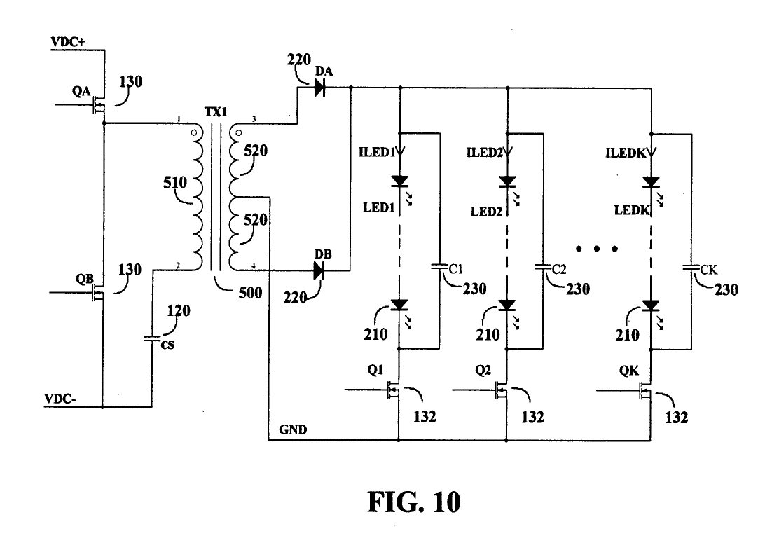

When the difference of the LED operating voltage is not too large, e.g. preferably within 5% of the nominal operating voltage value, the drive circuit can be further simplified to use one secondary winding to supply all the LED strings and use only synchronous regulation control to realize the current regulation and digital dimming control for each LED string. A typical example of such approach is illustrated in FIG. 10. As shown in FIG. 10, all the LED strings LED1 through LEDK are supplied from the single secondary winding 520 of transformer 500 through a single pair of full wave rectifier devices DA and DB, represented by 220 in the figure. A dedicated synchronous regulation switch 132 is connected in series between the cathode of each LED string and the ground return respectively. With the same format of gate control waveform VGC as described in FIG. 5, the synchronous regulation switch can fulfill the LED current regulation function by PWM controlled synchronous switching and also the digital dimming control function by turning on and off the current regulation function according to the digital dimming control signal. Because the PWM switching duty of the synchronous regulation operation is always narrower than duty of the AC supply power waveform, the regulation switch 132 can stay at off state during the zero crossing period of the AC supply waveform. Thus there is essentially no conduction path between the LED strings when the AC supply goes through zero crossing period. As explained in paragraph [0026], if a conduction path exists between the LED strings during such zero crossing period and with the existence of energy storage element such smoothing capacitor 230, cross energy dripping between the LED channels could occur and consequently affect the current control accuracy of the LED string. Herein because such cross conduction path is cut off by proper control of the regulation switch, smoothing capacitor 230 can be paralleled to each LED strings even all the string share a common pair of rectifier diodes. Further, during the off period of digital dimming operation the regulation switch is also turned off, completely eliminates the possibility of cross energy dripping between the LED channels. To further save the system cost, the smoothing capacitor 230 can also be removed if the LED strings are permitted to operate at rippled DC current.

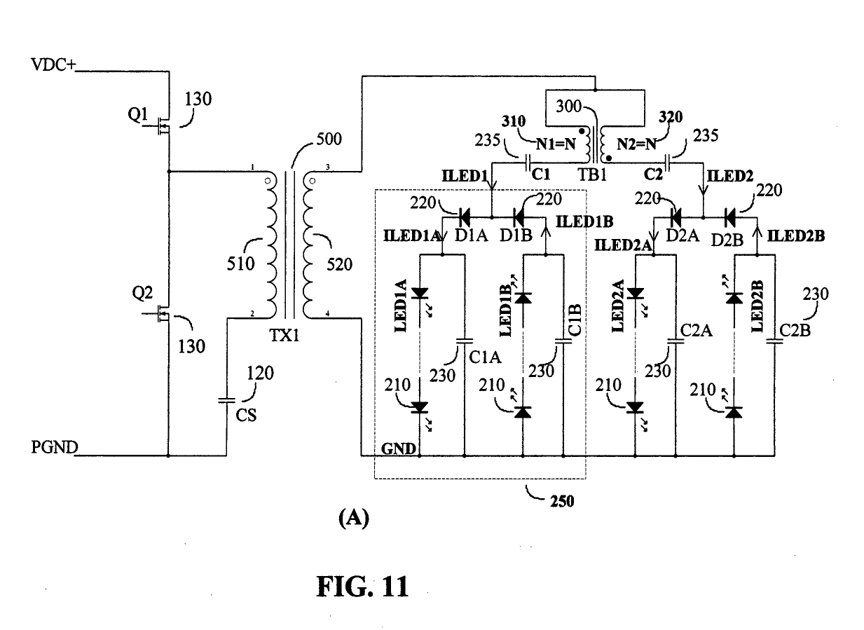

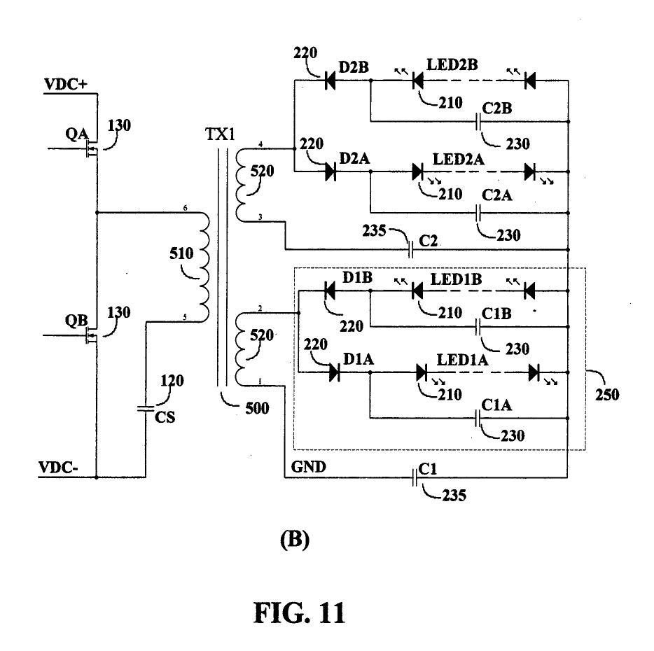

In the above described drive methods center tapped windings are employed as balancing components to supply DC current to the LED strings while generating AC excitation for the magnetic path for the components. If AC current can be used to drive LED strings directly, both the power transformer and the balancing component will not need to use canter tapped winding so that the complexity of these components can be further reduced. FIG. 11 shows three examples of such concept. As shown in FIG. 11, the LED strings are configured in pairs in anti-parallel connection to allow the current flowing through in both directions. For instance, in FIG. 11(A) string LED1A and diode D1A form a branch to allow their forward current to flow from upper side downwards, and LED1B and diode D1B form a branch to allow their forward current to flow from lower side upwards. The anti-parallel connection of these two branches forms a bi-directional circuit, represented as 250 in FIG. 11, to allow AC current to flow through them. Therefore the balancing winding can be connected in series with such anti-parallel structure to carry AC current. The circuit in FIG. 11(A) uses one balancing transformer 300 to drive two such anti-parallel LED circuit structures 250. The balancing transformer 300 is essentially the same as the one shown in FIG. 2 except that the center tap is removed. Also the two windings have the same number of turns and the polarity relation follows the flux canceling principle as well. As shown, both windings 310 and 320 are connected in series with an anti-parallel LED structure respectively. During operation the currents flowing through the two windings also follows the relation established in [EQU. 1], and because both windings have the same number turns, the currents flowing to the anti-parallel structures through them are equal. Further, it is well understand to the skilled in the art that because of the existence of the capacitor 120 in series with the primary winding 510 of transformer 500 and the intrinsic nature of the transformer, the current delivered from the secondary winding to the LED structures will have balanced amplitude in positive and negative half cycle, therefore the current delivered to the two LED strings of each anti-parallel structure during the positive and negative half cycle respectively will also have the same amplitude. So eventually balanced current is obtained for all the four LED strings LED1, LED2, LED3 and LED4. If a DC offset exists in the system that causes imbalance of the AC current amplitude in the positive and negative half cycle and consequently affects the current balance of the two LED strings in the anti-parallel LED structure, an AC coupling capacitor 235 can be inserted in series with each anti-parallel LED structure to cancel the DC offset and ensure the balance of the LED string current. Note in FIG. 11 smoothing capacitor 230 is provided in parallel with the LED strings to smooth the LED current. Since capacitor does not pass DC current from steady state operation of view, the existence of 230 will not affect the LED current balancing performance but will benefit the LED operation with lower current ripple.

FIG. 11(B) shows the implementation of anti-parallel LED structure with another type of balancing mechanism. The power transformer 500 in FIG. 11(B) has two secondary windings and each of them drives an anti-parallel LED structure 250. As elaborated in paragraph [0030], transformer 500 is purposely made with large leakage inductance and the leakage inductances of the two secondary windings 520 are closely matched and utilized to balance the current of the two anti-parallel LED structures 250 comprised by D1A, LED1A, D1B, LED1B, and D2A, LED2A, D2B, LED2B, respectively. The capacitor 230 in parallel with the LED strings also serves the function of reducing the ripple current of the LED strings but does not affect the current balancing performance. AC coupling capacitor 235 can also be added in series to the anti-parallel LED structure to cancel out the DC offset in the AC current waveform if any. In addition, when all the AC coupling capacitors 235 use the same capacitance value and the capacitive impedance is significant enough under the given operating frequency of the AC power source, their capacitive impedance can also be used as balancing impedance to balance the current of the anti-parallel LED strings. The principle of such concept is similar to the inductive impedance balancing mechanism as elaborated in paragraph [0027]. It should be noted that the two secondary winding structure of transformer 500 in FIG. 11(B) is by example only. More secondary windings can be used to drive more LED strings in practical implementations without departing from the spirit of this concept.

The above context has explained the principle of the invention. It should be emphasized that while certain embodiments of the inventions have been described, these embodiments have been presented by way of example only, and are not intended to limit the scope of the inventions in any circumstances. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

I claim:

1. A non-dissipative drive system to drive multiple LED strings with an inductive balancing mechanism to obtain even current distribution among the LED strings, the inductive balancing mechanism includes at least: an inductive balancing network comprised with a plurality of center tapped balancing windings with the number of turns of each winding between the first terminal and the center tap equals the number of turns between the second terminal and the center tap, a power transformer with at least one center tapped secondary winding to supply AC power from the said winding, the voltage from the first and second terminal of the said secondary winding assumes opposite polarity in reference to the center tap except at zero amplitude, at least one pair of rectifier diode couples energy from the power transformer winding to the inductive balancing network with the first diode connected between the first terminal of the transformer winding and the first terminal of the balancing windings and the second diode between the second terminal of the transformer winding and the second terminal of the balancing windings; a plurality of LED strings of the same number as the balancing windings are connected between the center tap of each balancing winding respectively and the center tap of the power transformer secondary winding, the polarity relation of the rectifier diodes and the LED strings is such that they are forward biased simultaneously when current flows in the loop formed from the first terminal of the transformer winding through the diode to the first terminal of the balancing winding and then from the center tap of the balancing winding through the LED string to the center tap of the transformer winding, and also in the loop formed from the second terminal of the transformer winding through the diode to the second terminal of the balancing winding and then from the center tap of the balancing winding through the LED string to the center tap of the transformer winding, when an AC power is supplied from the power transformer secondary winding, DC current flows through the LED strings between the center tap of the power transformer secondary winding and the balancing winding, and the magnetic path of the balancing winding is excited with AC flux.

2. The non-dissipative LED drive system according to claim 1, with two center tapped balancing windings coupled through a common magnetic path, the polarity relation of the two balancing windings is such that when operating current flows through the two balancing windings, the fluxes generated from the two windings cancel each other in the common magnetic path, the current of the LED strings are forced to be equal when the two balancing windings use the same number of turns.

3. The non-dissipative LED drive system according to claim 1, a plurality of balancing windings are not magnetically coupled with each other, the inductance of the balancing winding is utilized to balance the current of the LED strings, the LED current is forced to be approximately equal when the balancing windings have the same inductance.

4. The non-dissipative LED drive system according to claim 1, the number of the rectifier diode pair is changed to a plurality of pairs that equals to the number of the balancing windings, the first diode of each rectifier pair is connected between the first terminal of the power transformer winding and the first terminal of the balancing winding respectively, and the second diode of the rectifier pair is connected between the second terminal of the power transformer winding and the second terminal of the balancing winding respectively, with such connection the current flowing path between the LED strings is totally cut off and smoothing capacitors can paralleled to the LED strings without affecting the balancing result.

5. A non-dissipative LED drive system according to claim 1, with the center tapped balancing winding integrated with the center tapped secondary winding of the power transformer, the leakage inductance of the transformer secondary winding works as the balancing inductance, the number of the secondary winding of the power transformer and the number of rectifier diode pair equal to the number of LED strings to be driven, the first diode of each rectifier pair is connected between the first terminal of the corresponding transformer secondary winding and the first terminal of the corresponding LED string, the second diode of the rectifier pair is connected between the second terminal of the corresponding transformer secondary winding and the first terminal of the corresponding LED string, the second terminal of the LED string is connected to the center tap of the corresponding transformer secondary winding, the polarity relation of the rectifier diode and its corresponding LED string is such that they are forward biased simultaneously when current flows in the loop from the first terminal of the transformer secondary winding, through the first rectifier diode, the LED string, and returns to the center tap of the transformer secondary winding, and also in the loop from the second terminal of the transformer secondary winding, through the second rectifier diode, the LED string, and return to the center tap of the transformer secondary winding, the leakage inductances of the transformer secondary windings are made equal, and the currents of the LED strings are balanced by the matched leakage inductance of the transformer secondary winding.

6. A synchronous regulation method to control the LED operating current and dimming operation, the implementation system comprises a LED drive system of claim 1 with an addition to insert a regulation switch between the center tap of the power transformer winding and the common terminal of the LED strings that is originally connected to the center tap of the power transformer winding in claim 1, the regulation switch performs both the functions of LED current regulation and digital dimming operation, during the on period of the digital dimming operation the regulation switch regulates the LED current with pulse width modulated switching action, the switching action of the regulation switch is in synchronous with the positive and negative half cycle of the AC supply from the power transformer winding, the regulation switch controls the total current of the LED strings and the regulated total current is evenly distributed to the LED strings by the inductive balancing network, during the off period of the digital dimming operation the regulation switch is turned off to cut off the LED current.

7. A synchronous regulation system according to claim 6, with the LED drive system of claim 1 replaced by the LED drive system of claim 2, the balancing network consists of two center tapped balancing windings coupled through a common magnetic path, the polarity relation of the two balancing windings is such that when operating current flows through the two balancing windings, the fluxes generated from the two windings cancel each other in the common magnetic path, the two balancing windings use the same number of turns, during active period of the regulation switch operation the total LED current is regulated to the target value by the regulation switch and the regulated total current is evenly distributed to the LED strings by the balancing network, during the off period of the digital dimming operation the regulation switch is turned off to cut off the LED current.

8. A synchronous regulation system according to claim 6, with the LED drive system of claim 1 replaced by the LED drive system of claim 3, the balancing network consists of a plurality of balancing windings that are not magnetically coupled with each other, the inductance of the balancing winding is utilized to balance the current of the LED strings, the balancing windings have the same inductance, during active period of the regulation switch operation the total LED current is regulated to the target value by the regulation switch and the regulated total current is evenly distributed to the LED strings by the balancing network, during the off period of the digital dimming operation the regulation switch is turned off to cut off the LED current.

9. A synchronous regulation system according to claim 6, with the LED drive system of claim 1 replaced by the LED drive system of claim 4, the number of the rectifier diode pair is changed to a plurality of pairs that equals to the number of the balancing windings, the first diode of each rectifier pair is connected between the first terminal of the power transformer winding and the first terminal of the balancing winding respectively, and the second diode of the rectifier pair is connected between the second terminal of the power transformer winding and the second terminal of the balancing winding respectively, a smoothing capacitor is connected in parallel to each LED string to reduce the ripple content of the LED current, during active operation period of the regulation switch the total LED current is regulated to the target value by the regulation switch and the regulated total current is evenly distributed to the LED strings by the balancing network, during the off period of the digital dimming operation the regulation switch is turned off to cut off the LED current.

10. A synchronous regulation system according to claim 6, with the LED drive system of claim 1 replaced by the LED drive system of claim 5, the center tapped balancing winding is integrated with the center tapped secondary winding of the power transformer, and the leakage inductance of the transformer secondary winding works as the balancing inductance, during active operation period of the regulation switch the total LED current is regulated to the target value by the regulation switch and the regulated total current is evenly distributed to the LED strings by the matched leakage inductance of the transformer secondary winding, during the off period of the digital dimming operation the regulation switch is turned off to cut off the LED current.

11. A synchronous regulation method to control the operating current and dimming operation of each individual LED string of a multiple LED string system independently, the implementation system includes at least a power transformer, a pair of rectifier diode, a plurality of LED strings, and a plurality of regulation switches in correspondence to the number of LED strings, the power transformer has at least one center tapped secondary winding, the first terminal of the LED strings are connected together as a common node, the first diode of the rectifier pair is connected between the first terminal of the transformer secondary winding and the common node of the LED strings, the second diode is connected between the second terminal of the transformer secondary winding and the common node of the LED strings, each regulation switch is connected between the second terminal of its corresponding LED string and the center tap of the transformer secondary winding, the polarity relation of the rectifier diodes and the LED strings is such that they are forward biased simultaneously when current flows in the loop from the first terminal of the transformer secondary winding, through the first rectifier diode, the LED strings and the regulation switches, and to the center tap of the transformer secondary winding, and also in the loop from the second terminal of the transformer secondary winding, through the second rectifier diode, the LED strings and the regulation switches, and to the center tap of the transformer secondary winding, the regulation switches fulfill both the functions of current regulation and digital dimming operation for their corresponding LED string independently from each other, during the on period of the digital dimming operation the regulation switch regulates the LED current with pulse width modulated switching action, the switching action of the regulation switch is in synchronous with the positive and negative half cycle of the AC supply from the transformer secondary winding, during the off period of the digital dimming operation the regulation switch is turned off to cut off the current of the LED strings.

12. A synchronous regulation system of claim 9, with the exception that the power transformer has a plurality of center tapped secondary windings in correspondence to the number of the LED strings, and also a plurality of rectifier diode pairs in correspondence to the number of the LED strings, the first diode of each rectifier pair is connected between the first terminal of the corresponding transformer secondary winding and the first terminal of the corresponding LED string, the second diode of the rectifier pair is connected between the second terminal of the corresponding transformer secondary winding and the first terminal of the corresponding LED string, the second terminal of the LED string is connected to the center tap of the corresponding transformer secondary winding, the polarity relation of the rectifier diode and its corresponding LED string is such that they are forward biased simultaneously when current flows in the loop from the first terminal of the transformer secondary winding, through the first rectifier diode, the LED string and the regulation switch, and to the center tap of the transformer secondary winding, and also in the loop from the second terminal of the transformer secondary winding, through the second rectifier diode, the LED string and the regulation switch, and to the center tap of the transformer secondary winding, the regulation switches fulfill both the functions of current regulation and digital dimming operation for their corresponding LED string independently from each other, during the on period of the digital dimming operation the regulation switch regulates the LED current with pulse width modulated switching action, the switching action of the regulation switch is in synchronous with the positive and negative half cycle of the AC supply from the transformer secondary winding, during the off period of the digital dimming operation the regulation switch is turned off to cut off the current of its corresponding LED string.

13. Another type of non-dissipative drive system to drive multiple LED strings with a balancing mechanism to obtain even current distribution among the LED strings, the system includes at least: a plurality of anti-parallel LED structure comprised with two LED strings, each string has a diode connected in series in the same forward direction with the LED string, and such two LED-diode strings are connected in anti-parallel to form an anti-parallel LED structure, an AC power source, and a balancing network that receives the AC power and distributes AC current evenly to the said anti-parallel LED structures with its reactive balancing mechanism under AC excitation, additionally a smoothing capacitor can be added in parallel to each LED string to reduce the ripple of the LED current.

14. A non-dissipative drive system according to claim 13, the balancing network is comprised by two inductive balancing windings coupled through a common magnetic path, the polarity relation of the two balancing windings is such that when operating current flows through the two balancing windings, the fluxes generated from the two windings cancel each other in the common magnetic path, each of the two balancing windings is connected in series with an said anti-parallel LED structure respectively to form a balancing branch, all the balancing branches are connected in parallel between the first and second terminal of the AC power source, the current of the LED strings are forced to be equal when the two balancing windings use the same number of turns.

15. A non-dissipative drive system according to claim 13, the balancing network is integrated into the AC power transformer, the AC power transformer has a plurality of secondary windings in correspondence to the number of anti-parallel LED structures to be driven, the leakage inductance of the transformer secondary winding is utilized to balance the current of the LED structure, each of the anti-parallel LED structures is connected between the first and second terminal of the corresponding secondary winding, even current distribution is obtained for the LED strings.

16. A non-dissipative drive system according to claim 13, with an addition of an AC coupling capacitor inserted in series to the anti-parallel LED structure to cancel the DC offset and ensure the balanced current amplitude of the two LED strings of the anti-parallel LED structure, the capacitive impedance of the AC coupling capacitor can also be utilized to balance the current of the LED strings when all they use the same capacitance value and capacitive impedance is significant enough under the given operating frequency of the AC power source.
